(19) United States
(12) Patent Application Publication
(10) Pub. No.: US 2014/0267114 A1
(43) Pub. Date: Sep. 18, 2014

(54) ADAPTIVE HUMAN MACHINE INTERFACES FOR PRESSURE SENSITIVE CONTROL IN A DISTRACTED OPERATING ENVIRONMENT AND METHOD OF USING THE SAME

(71) Applicant: TK Holdings, Inc., Auburn Hills, MI (US)

(72) Inventors: Jason Carl Lisseman, Shelby Township, MI (US); David Andrews, Ortonville, MI (US)

(73) Assignee: TK Holdings, Inc., Auburn Hills, CA (US)

(21) Appl. No.: 14/211,665

(22) Filed: Mar. 14, 2014

Related U.S. Application Data
(60) Provisional application No. 61/794,632, filed on Mar. 15, 2013.

(51) Int. Cl. G06F 3/041; G06F 3/01

(52) U.S. Cl. CPC G06F 3/0414; G06F 3/016
USPC 345/173

(57) ABSTRACT

An example method for providing an adaptive human machine interface that increases selectability and reduces distractibility of an operator controlling a system in a distracted operating environment is provided. The method can include receiving a combination of gestures on a pressure sensitive interface device. The combination can include at least two gestures received in temporal proximity, and each of the gestures can be characterized by a discretized pressure metric having a plurality of value ranges and a discretized time metric. The method can include selecting a control message from a plurality of control messages based on the combination of gestures and sending the selected control message to the system. The sizes of each of the value ranges for the discretized pressure metric and discretized time metric can be tuned to reduce distraction of the operator. The value ranges can be adjustable according to at least one characteristic of the operator.

### CROSS-REFERENCE TO RELATED APPLICATIONS

This application claims priority to U.S. Provisional Application No. 61/794,632, the contents of which are expressly incorporated herein in its entirety by reference. This application is related to an application filed concurrently herewith titled “Human Machine Interfaces For Pressure Sensitive Control In A Distracted Operating Environment and method of Using The Same.”

### BACKGROUND

The present disclosure relates generally to the field of pressure/force sensors, and more particularly to human machine interfaces for pressure/force sensitive control in a distracted operating environment.

Conventional control systems present operators with a combination of controls such as switches, buttons, levers, knobs, dials, etc. The operators interact with these control systems by manipulating the presented controls in order to execute various control functions. Recently, control systems have become increasingly complex due to the growing number of controllable features. As control systems increase in complexity, control panels become cluttered with switches, buttons, levers, knobs and/or dials. Accordingly, the control systems become more difficult to operate. In addition, it becomes difficult for engineers to design control panels that are capable of accommodating all of the necessary controls within a confined space.

Pressure/force sensitive control panels have been developed to address the problems in the related art. Pressure sensitive control panels are capable of sensing a magnitude of an applied force in addition to a location of an applied force. By sensing both the magnitude and location of the applied force, it is possible to provide a larger number of control functions in a simple, user-friendly format. Pressure sensitive control panels in the related art lack adequate pressure sensitivity and responsiveness.

Additionally, pressure sensitive control panels can be provided for controlling systems in distracted operating environments. In such environments, operators might interact with the pressure sensitive control panels while focusing on a primary task. For example, pressure sensitive control panels can be provided in vehicles and can be operated by drivers focusing on driving the vehicles. The operators therefore cannot divert their attention from the primary task to interact with the pressure sensitive control panels without compromising safety of the primary task.

### SUMMARY

Adaptive human machine interfaces for pressure sensitive control in a distracted operating environment are provided herein. Methods for providing adaptive human machine interfaces for pressure sensitive control in a distracted operating environment are also provided herein. The human machine interfaces can be configured to increase selectability of an operator. The human machine interfaces can therefore be configured to increase the number of control options available to the operator. Additionally, the human machine interfaces can be designed such that the operator can interact with the human machine interfaces in distracted operating environments. The human machine interfaces can also be designed to reduce distractibility of the operator. For example, the human machine interfaces can be designed to facilitate the operator selecting from a large number of control options using relatively gross (or coarse) gestures. For example, gestures can optionally be characterized by time and/or pressure metrics such as the time and/or amount of force applied to the pressure sensitive input device during the gestures. The time and/or pressure metrics can be selected to reduce distractibility of the operator. Optionally, the time and/or pressure metrics can be selected to facilitate the operator's ability to execute the gestures without receiving visual feedback. Different gestures can be characterized by different time and/or pressure metrics. The time and/or pressure metrics can therefore be selected to facilitate the operator's ability to execute one or more gross gestures and allow the controller to distinguish between different gestures. Additionally, a gesture can include a plurality of gestures executed/received in close temporal proximity (e.g., gestures executed/received in series) can be combined to select a control option. According to the implementations provided herein, it is possible to adapt characteristics of the gestures according to one or more characteristics of the operator.

An example method for providing an adaptive human machine interface that increases selectability and reduces distractibility of an operator controlling a system in a distracted operating environment is provided herein. The method can include receiving a combination of gestures on a pressure sensitive interface device. The combination of gestures can include at least two gestures received in temporal proximity, and each of the at least two gestures can be characterized by a discretized pressure metric having a plurality of value ranges and a discretized time metric. The method can also include selecting a control message from a plurality of control messages based on the combination of gestures and sending the selected control message to the system. The sizes of each of the value ranges for the discretized pressure metric and discretized time metric can be tuned to reduce distraction of the operator. Additionally, the value ranges can be adjustable according to at least one characteristic of the operator.

Optionally, a total number of control messages can be related to a number of each of the discretized time and discretized pressure metrics for the at least two gestures.

Optionally, the at least one characteristic of the operator can be associated with an identifier for the operator. Additionally, the method can optionally include receiving the identifier for the operator and adjusting the value ranges of the discretized pressure metric for at least one of the gestures based on the at least one characteristic of the operator.

Alternatively or additionally, the method can include learning the at least one characteristic of the operator and adjusting the value ranges of the discretized pressure metric for at least one of the gestures based on the at least one characteristic of the operator. Optionally, the at least one characteristic of the operator can be at least one of a peak or average force applied to the pressure sensitive input device.

Alternatively or additionally, each of the at least two gestures can be at least one of a tap gesture, a hold gesture and a swipe gesture.

An example method for providing an adaptive human machine interface that decreases distractibility of an operator controlling a system in a distracted operating environment can include receiving a gesture on a pressure sensitive input device, the gesture being characterized by a discretized pressure metric having a plurality of value ranges. The method can also include selecting a control message from a plurality of control messages based on the gesture and sending the selected control message to the system. The size of each of the value ranges for the discretized pressure metric can be tuned to reduce distraction of the operator. Additionally, each of the value ranges for the discretized pressure metric can be defined based on a predictable electrical property-force response curve for the pressure sensitive input device. Further, the value ranges can be adjustable according to at least one characteristic of the operator.

Optionally, the at least one characteristic of the operator can be associated with an identifier for the operator. Additionally, the method can optionally include receiving the identifier for the operator and adjusting the value ranges of the discretized pressure metric based on the at least one characteristic of the operator. For example, at least one of the value ranges of the discretized pressure metric can be shifted along the predictable electrical property-force response curve.

Alternatively or additionally, the method can include learning the at least one characteristic of the operator and adjusting the value ranges of the discretized pressure metric based on the at least one characteristic of the operator. For example, at least one of the value ranges of the discretized pressure metric can be shifted along the predictable electrical property-force response curve.

Additionally, the predictable electrical property-force response curve can be defined by a power log curve. Alternatively or additionally, the predictable electrical property-force response curve can be a resistance-force response curve.

Optionally, the at least one characteristic of the operator can be at least one of a peak or average force applied to the pressure sensitive input device. In addition, the gesture can be further characterized by a time metric. Alternatively or additionally, the gesture can include at least two gestures received in temporal proximity on the pressure sensitive input device. Each of the gestures can be characterized by a discretized pressure metric having a plurality of value ranges and a time metric. The control message can be selected based on a combination of the at least two gestures. Optionally, the gesture can include one or more of a tap gesture, a hold gesture and a swipe gesture.

It should be understood that the above-described subject matter may also be implemented as a computer-controlled apparatus (e.g., a human machine interface for a system), a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a simplified block diagram of an example sensor system;

FIG. 2A is a cross-sectional view illustrating an example pressure sensor that may be included in the sensor of FIG. 1;

FIG. 2B is a cross-sectional view illustrating another example pressure sensor that may be included in the sensor of FIG. 1;

FIGS. 2C-2E illustrate example electrode and electrical trace configurations included in the pressure sensors described herein;

FIG. 3A is a plan view illustrating an example pressure sensing unit included in the pressure sensors of FIGS. 2A-2B;

FIGS. 3B-3E are example circuit diagrams of voltage dividers for sensing a position and magnitude of a force applied to the pressure sensing unit of FIG. 3A;

FIG. 4A is a plan view illustrating another example pressure sensing unit included in the pressure sensors of FIGS. 2A-2B;

FIGS. 4B-4D are example circuit diagrams of voltage dividers for sensing a position and magnitude of a force applied to the pressure sensing unit of FIG. 4A;

FIG. 5A is a cross-sectional view illustrating an example pressure sensor that may be included in the sensor of FIG. 1;

FIG. 5B are cross-sectional views of covers included in the pressure sensor of FIG. 5A;

FIG. 6A illustrates an example Resistance-Force response curve of a pressure sensitive material according to an implementation of the invention;

FIG. 6B illustrates example Resistance-Force response curves of a pressure sensitive material according to an implementation of the invention;

FIG. 6C illustrates Resistance-Force response curve shifting according to an implementation of the invention;

FIGS. 7A-7J are example gesture timing and gesture combination tables;

FIG. 7K is a chart showing the fastest and slowest responses for the gestures and gesture combinations in the examples of FIGS. 7B, 7C and 7F-7J;

FIG. 8 is an example table of control functions in an automotive environment;

FIG. 9 illustrates an example path of a force applied to the sensor of FIG. 1;

FIG. 10A illustrates an example average Resistance-Force response curve according to an implementation of the invention;

FIG. 10B illustrates an example power log function curve fitting the example average Resistance-Force response curve of FIG. 10A;

FIG. 10C illustrates example power log function curves fitting the three-sigma Resistance-Force response curves of FIG. 10A;

FIG. 11 illustrates adapting gestures according to one or more characteristics of an operating using a predictable Resistance-Force response curve;

FIG. 12A is a flow diagram illustrating example operations for providing an adaptive human machine interface that reduces distractibility of an operator controlling a system in a distracted environment; and

FIG. 12B is a flow diagram illustrating example operations for providing an adaptive human machine interface that increases selectability and reduces distractibility of an operator controlling a system in a distracted environment.

### DETAILED DESCRIPTION

Implementations of the present disclosure now will be described more fully hereinafter. Indeed, these implementations can be embodied in many different forms and should not be construed as limited to the implementations set forth herein; rather, these implementations are provided so that this disclosure will satisfy applicable legal requirements. Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a”, “an”, “the”, include plural referents unless the context clearly dictates otherwise. The term “comprising” and variations thereof as used herein is used synonymously with the term “including” and variations thereof and are open, non-limiting terms.

The term “sheet” as used herein may refer to a structure with a thickness that is a fraction of its remaining two linear dimensions. It need not be a very small thickness with flat surfaces, but could instead be a layer with two relatively opposing surfaces between edges of any general shape between which is defined a thickness, or range of thicknesses that is 1/10, ¼, ⅓ or ½ of a width or length of the opposed surfaces, for example. Also, the opposing surfaces do not need to be flat or regular in finish, nor precisely parallel from each other. The term “thin sheet” may refer to a sheet with thickness of less than 1/10 a dimension of one of the opposing surfaces.

Referring to FIG. 1, a block diagram of a sensor system 100 according to an implementation of the invention is shown. The sensor system 100 is an example of a human machine interface for controlling a system as discussed in further detail below. The sensor system 100 may be used to sense a position and magnitude of force applied to the sensor system 100. In other words, the sensor system 100 may be configured to sense the position of the applied force in either one dimension (e.g., the X- or Y-direction) or two dimensions (e.g., the X- and Y-directions), as well of as the magnitude of the applied force (e.g., force in the Z-direction). The sensor system 100 may include a computing unit 106, a system clock 105, a pressure sensor 107 and communication hardware 109. In its most basic form, the computing unit 106 may include a processor 102 and a system memory 104. The processor 102 may be a standard programmable processor that performs arithmetic and logic operations necessary for operation of the sensor system 100. The processor 102 may be configured to execute program code encoded in tangible, computer-readable media. For example, the processor 102 may execute program code stored in the system memory 104, which may be volatile or non-volatile memory. The system memory 104 is only one example of tangible, computer-readable media. Other examples of tangible, computer-readable media include floppy disks, CD-ROMs, DVDs, hard drives, flash memory, or any other machine-readable storage media, wherein when the program code is loaded into and executed by a machine, such as the processor 102, the machine becomes an apparatus for practicing the disclosed subject matter.

In addition, the sensor system 100 may include the pressure sensor 107 that is configured to change at least one electrical property (e.g., resistance) in response to forces applied to the sensor system 100. The pressure sensor 107 is an example of a pressure sensitive input device as discussed in further detail below. Additional examples of pressure sensors are discussed below with regard to FIGS. 2A-2B and 5A. Further, the sensor system 100 may include communication hardware 109 that interfaces with the pressure sensor 107 and receives/measures the sensed changes in the at least one electrical property of the pressure sensor 107. Example communication hardware 109 is discussed below with regard to FIGS. 3A-3E and 4A-4D. Additionally, the sensor system 100 may include a system clock 105. The processor 102 may be configured to associate the sensed changes in the at least one electrical property of the pressure sensor 107 with a time from the system clock 105 and store the sensed changes and corresponding time to the system memory 104. Optionally, the processor 102 may be configured to analyze the stored data and associate measured changes in the at least one electrical property of the pressure sensor 107 with various control messages for controlling system functions.

Referring to FIG. 2A, a cross-sectional view of a pressure sensor 200A according to an exemplary implementation of the invention is shown. The pressure sensor 200A may include sheets of carrier material 202, 204, conductors 206, 208, electrodes 203, 205 and a pressure sensitive material 201 configured in a generally symmetric, layered relationship (e.g., a carrier sheet, conductor, and electrode disposed on each side of the pressure sensitive material). The carrier sheets 202, 204, conductors 206,208, electrodes 203, 205 and pressure sensitive material 201 may be selectively configured to change conductive or electrical characteristics of the pressure sensor 200A according to the forces (or pressures) expected during a dynamic application of pressure. In some implementations, the pressure sensor 200A may include an array of pressure sensing units, each sensing unit including conductors 206, 208, electrodes 203, 205, and pressure sensitive material 201.

The pressure sensitive material 201 may be configured to change at least one electrical property in response to force (or pressure) applied. For example, the pressure sensitive material 201 may be configured to change resistance (e.g., become more or less conductive) in response to applied force. In some implementations, the pressure sensitive material 201 may behave substantially as an insulator in the absence of an applied force and decrease in resistance as the magnitude of the applied force increases. The variable electrical property of the pressure sensitive material 201 may be capable of changing nearly instantaneously, or in near real-time, in response to changes in the applied force. In other words, the variable electrical property of the pressure sensitive material 201 may change such that the user is incapable of detecting a lag between the change in applied force and the change in the electrical property during operation. In addition, the electrical property may continuously vary in response to the applied force. For example, predictable Resistance-Force response curves of a pressure sensitive material according to an implementation of the invention are discussed below with regard to FIGS. 6A and 6B.

The pressure sensitive material 201 may be relatively thin compared to the other layers of the pressure sensor 200A. For example, the pressure sensitive material 201 may be a thin sheet. The pressure sensitive material 201 may be configured to act as an X-Y position coordinate (or just an X- or Y-position coordinate) and Z pressure coordinate sensor, such as the sensors employed in commonly owned U.S. patent application Ser. No. 13/076,226 entitled “Steering Wheel Sensors” and filed on Mar. 30, 2011, which is incorporated herein in its entirety by reference. Additional details about the operation of a pressure sensitive material in X, Y and Z space may be found in PCT Patent Application Publication No. WO 2010/109186 entitled “Sensor” and published on Sep. 30, 2010, which is incorporated herein in its entirety by reference. The pressure sensitive material 201 may have a range of shapes depending upon the intended application, such as the rectangular shape shown in FIGS. 3A and 4A. The rectangular shape facilitates use of full X-Y position coordinates. Or, for example, the pressure sensitive material 201 may have an elongate or strip shape for single-axis translation or may have a circular shape for rotational coordinate registration.

The pressure sensitive material 201 may be an electro-active material. The pressure sensitive material 201 may, for example, be a carbon nanotube conductive polymer. The pressure sensitive material 201 may be applied to one of the pair of electrodes 203, 205 by a printing process, such as two- or three-dimensional ink jet or screen printing, vapor deposition, or conventional printed circuit technique, such etching, photo-engraving or milling. As smaller particle sizes are used, such as that of graphene or a graphene conductive polymer, the pressure sensitive material 201 may also be applied through conventional printed circuit techniques, such as vapor deposition. According to other examples, the pressure sensitive material 201 may be a silicene polymer material doped with a conductor, such as silver or copper.

According to other examples, the pressure sensitive material 201 may be a quantum tunneling composite (QTC), which is a variable resistance pressure sensitive material that employs Fowler-Nordheim tunneling. The QTC is a material commercially made by Peratech (www.peratech.com), of Brompton-on-Swale, UK. The QTC has the ability to change from a near-perfect electrical insulator (>10¹²Ω) in an unstressed state to a near-perfect conductor (<1Ω) when placed under enough pressure. The QTC relies on tunneling conduction, as opposed to percolation, as the conduction mechanism. An electron may be described as a wave, and therefore, the electron possesses a determinable probability of crossing (i.e., tunneling) through a potential barrier. The QTC comprises conductive metal filler particles in combination with an insulator, such as silicone rubber. The metal filler particles may get close to each other, but do not touch, due to the insulator. In order to increase the probability that tunneling will occur, the conductive metal filler particles are provided with spikes that increase the localized electric field at the tips of the spikes, which reduces the size of the effective potential barrier between particles. In addition, when the QTC is placed under pressure, the metal filler particles are forced closer together, which reduces the size of the effective potential barrier between particles. Accordingly, the QTC material in the pressure sensor 200A may act as an insulator when zero pressure or zero force is applied, since the conductive particles may be too far apart to conduct, but as force or pressure is applied, the conductive particles move closer to other conductive particles, so that electrons can pass through the insulator, which changes the resistance of the QTC. Thus, the resistance of the QTC in the pressure sensor 200A is a function of the force or pressure acting upon the pressure sensor 200A.

The carrier sheets 202, 204 are coupled together to form the pressure sensor 200A after the conductors 206, 208, electrodes 203, 205, and pressure sensitive material 201 are deposited thereon. The carrier sheets 202, 204 may, for example, be laminated together, such that the conductors 206, 208, electrodes 203, 205, and pressure sensitive material 201 are in proper alignment. The lamination process may for example be a conventional process using heat and pressure. Adhesives may also be used. The total thickness of the pressure sensor 200A may be approximately 120 microns. According to other examples, the carrier sheets 202, 204 may, for example, be coupled together in other manners (e.g., laminating without heat or pressure). Further, the pressure sensor 200A may have a different total thickness (e.g., greater than or equal to approximately 70 microns).

Referring to FIG. 2B, another example pressure sensor 200B is shown. The pressure sensor 200B includes carrier sheets 202, 204, electrodes (i.e., conductive pads) 203, 205 and pressure sensitive material 201. The pressure sensor 200B may be formed by printing or depositing electrodes 203 and 205 on carrier sheets 202 and 204, respectively. The conductive pads, for example, may be comprised of printed carbon, copper, tin, silver or other electro-active materials.

In addition, the pressure sensitive material 201 may then be printed or deposited over one of electrodes 203 or 205. For example, as shown in FIG. 2B, the pressure sensitive material 201 may be printed or deposited over electrode 205. The pressure sensor 200B may then be formed by bonding carrier sheets 202 and 204. For example, carrier sheets 202 and 204 may be bonded through a support layer 208. As discussed above, the pressure sensitive material 201 may be configured to change at least one electrical property in response to force (or pressure) applied. For example, the pressure sensitive material 201 may be configured to change resistance (e.g., become more or less conductive) in response to applied force. Thus, when force (or pressure) is applied, the pressure sensor 200B becomes conductive and current flows between electrodes 203 and 205. In addition, the magnitude of electrical conduction between electrodes 203 and 205 varies in relation to the magnitude of force applied to the pressure sensor 200B. As discussed below with regard to FIG. 6C, it may be possible to change the electrical property-force response curve by changing one or more of the characteristics of the layers of the pressure sensor 200B, such as the dimensions and/or materials of the layers of the pressure sensor 200B.

Although not shown in FIG. 2B, conductors or electrical traces may be printed or deposited on each of electrodes 203 and 205. The conductors or electrical traces may provide electrical connections to electrodes 203 and 205. For example, the conductors or electrical traces may be conductors used in voltage divider circuits discussed below with regard to FIGS. 3A-3E and 4A-4D. In particular, the conductors or electrical traces may be configured for measuring position coordinates (X- and Y-position coordinates or an X- or Y-position coordinate) and an amount of force applied. Alternatively, the conductors or electrical traces may be configured for measuring an amount of force applied to the pressure sensor. In this configuration, the pressure sensor may be used to detect application of a force exceeding a predetermined threshold, for example. As discussed above, the pressure sensitive material may have a predictable electrical property-force response curve, and therefore, it may be possible to detect application of a force exceeding a predetermined threshold by measuring the electrical property of the pressure sensitive material.

Referring to FIG. 2C, an example electrode and electrical trace configuration for measuring an amount of force is shown. FIG. 2C illustrates a plan view of electrodes 220C and conductors or electrical traces 222C. In this example, the pressure sensitive material may be disposed between electrodes 220C when electrodes 220C are incorporated into a pressure sensor. As discussed above, the pressure sensitive material may be printed or deposited over one of electrodes 220C. In FIG. 2C, the electrical traces 222C are connected at the periphery of each electrode 220C. For example, the conductors or electrical traces 222C are electrically connected at a point along the periphery of each electrode 220C.

There may be resistance variation related to the distance between the contact point on the pressure sensor (i.e., the point where force is applied to the sensor) and the point where the electrical traces 222C are connected to the electrodes 220C. For example, FIG. 2D illustrates a number of contact points 225 relative to an electrode 220D of the pressure sensor. In FIG. 2D, the sheet resistance of the electrode 220D between the contact points 225 and the point where the electrical trace 222D is connected to the electrode 220D increases as the distance between the contact points 225 and the point where the electrical trace 222D is connected to the electrode 220D increase. The resistance variation may be at a maximum when the contact point on the pressure sensor is located at a point on the periphery of the electrode 220D directly opposite to a point on the periphery of the electrode 220D where the electrical trace 222D is connected.

As discussed above, the pressure sensitive material may have a predictable electrical property-force response curve, which may be used to determine the magnitude of force applied to the pressure sensor. However, because the sheet resistance of the electrode 220D is variable, application of the same magnitude of force on the pressure sensor at different locations relative to the point where the electrical trace 222D is connected to the electrode 220D yields different measured electrical properties (e.g., resistances), which are correlated with different measured force values along the electrical property-response curve. Accordingly, the resistance variation caused by the distance between the contact points 225 on the pressure sensor and the point where the electrical trace 222D is connected to the electrode 220D may introduce errors in calculating the magnitude of the applied force based on the measured electrical property.

In order to minimize resistance variation caused by the distance between the contact points 225 on the pressure sensor and the point where the electrical trace 222D is connected to the electrode 220D, electrical traces may disposed on or adjacent to the periphery of the electrodes. For example, as shown in FIG. 2E, the electrical traces 222E may be printed or deposited on or adjacent to the periphery of electrodes 220E. In FIG. 2E, the electrical traces 222E are provided along approximately the entire periphery of electrodes 220E. Alternatively, the electrical traces may be provided along a portion of the periphery of the electrodes, such as in a partial arc. In this configuration, the distance between the contact points on the pressure sensor and the point where the electrical trace is connected to the electrode may be reduced by as much as half the distance between the center and the periphery of the electrode.

Selective placement of the electrical traces may also be used to shrink contact point distances for a variety of shapes and sizes of electrodes. For example, peripheral placement could be near the edges of a square electrode or undulating lines along a rectangular electrode.

FIG. 3A illustrates an example pressure sensing unit 300 included in the sensors of FIGS. 2A-B. The pressure sensing unit 300 may include electrodes 302, 306, conductors 308, 310, 312, 314 and a pressure sensitive material 301. FIGS. 3B-3E illustrate voltage divider circuit diagrams for detecting X-Y-Z coordinate information using four communication lines (e.g., conductors 308, 310, 312, 314). As shown in FIG. 3A, electrode 302 may include conductors 308, 310, each conductor being arranged substantially in parallel on opposite sides of a surface of electrode 302. By applying a voltage across conductors 308, 310, it is possible to establish a potential between the conductors. In addition, electrode 306 may include conductors 312, 314, each conductor being arranged substantially in parallel on opposite sides of a surface of electrode 306. By applying a voltage across conductors 312, 314, it is possible to establish a potential between the conductors. In the implementation shown in FIG. 3A, the electric potential between the conductors of electrode 302 and the electric potential between the conductors of electrode 306 may be substantially perpendicular.

Referring to FIG. 3B, a voltage divider circuit diagram for detecting the position of applied force in a first direction (e.g., the X-direction) is shown. As discussed above, a voltage may be applied across conductors 312, 314 in order to establish a potential between the conductors. For example, a positive voltage may be applied to conductor 314 and conductor 312 may be grounded. The positive voltage may be 5V, for example. However, the positive voltage may be greater than or less than 5V. When a pressure is applied to the pressure sensing unit 300, electrodes 302, 306 may each contact the pressure sensitive material 301 at a contact point, and a voltage of electrode 306 is applied to electrode 302 via the pressure sensitive material 301 at the contact point. Then, voltage may be measured at terminal 320B (i.e., conductor 308) while conductor 310 is disconnected. The voltage at terminal 320B is proportional to the distance between the contact point and conductor 308. In particular, the voltage at the terminal 320B is proportional to the sheet resistance of electrode 302 between the contact point and conductor 308. Accordingly, the position of applied force in the first direction may be derived from the voltage at terminal 320B. In addition, the roles of the conductors 308, 310 and 312, 314 may be reversed (e.g., the positive voltage may be applied to conductor 312 and conductor 314 may be grounded and/or the voltage may be measured at conductor 310 while conductor 308 is disconnected).

Referring to FIG. 3C, a voltage divider circuit diagram for detecting the position of applied pressure in a second direction (e.g., the Y-direction) is shown. As discussed above, a voltage may be applied across conductors 308, 310 in order to establish a potential between the conductors. For example, a positive voltage may be applied to conductor 310 and conductor 308 may be grounded. When a force is applied to the pressure sensing unit 300, electrodes 302, 306 may each contact the pressure sensitive material 301 at a contact point, and a voltage of electrode 302 is applied to electrode 306 via the pressure sensitive material 301 at the contact point. Then, voltage may be measured at terminal 320C (i.e., conductor 312) while conductor 314 is disconnected. The voltage at terminal 320C is proportional to the distance between the contact point and conductor 312. In particular, the voltage at the terminal 320C is proportional to the sheet resistance of electrode 306 between the contact point and conductor 312. Accordingly, the position of applied force in the second direction may be derived from the voltage at terminal 320C. In addition, the roles of the conductors 308, 310 and 312, 314 may be reversed.

Referring to FIGS. 3D and 3E, voltage divider circuits for detecting a magnitude of applied force in a third direction (e.g., the Z-direction) are shown. A positive voltage (e.g., 5 V) may be applied to conductor 308 of electrode 302 while conductor 310 is disconnected, as shown in FIG. 3D. In addition, conductor 314 of electrode 306 may be connected to ground through a resistor R while conductor 312 is disconnected. The resistor R may have a known value, for example 4.7 kΩ, or any other known resistance value. When a force is applied to the pressure sensing unit 300, electrodes 302, 306 may each contact the pressure sensitive material 301 at a contact point, and current may flow from conductor 308 to conductor 314 through the contact point. Then, voltage may be measured at terminal 320D (i.e., conductor 314), which represents the voltage drop across resistor R. Further, as shown in FIG. 3E, a positive voltage (e.g., 5 V) may be applied to conductor 312 of electrode 306 while conductor 314 is disconnected. In addition, conductor 310 of electrode 302 may be connected to ground through a resistor R (with a known value, for example 4.7 kΩ) while conductor 308 is disconnected. When a force is applied to the pressure sensing unit 300, electrodes 302, 306 may each contact the pressure sensitive material 301 at a contact point, and current may flow from conductor 312 to conductor 310 through the contact point. Then, voltage may be measured at terminal 320E (i.e., conductor 310), which represents the voltage drop across resistor R. In addition, the roles of the conductors 308, 310 and 312, 314 may be reversed.

By using the voltages measured at terminals 320D and 320E, it is possible to derive the value of the resistance of the conductive path (e.g., Rz shown in FIGS. 3D and 3E). For example, the resistance Rz is proportional to the sum of the inverse of the voltage measured at terminal 320D and the inverse of the voltage measured at terminal 320E. In addition, as discussed above, the resistance Rz is the resistance of the pressure sensitive material 301, which is dependent on the magnitude of the force applied to the pressure sensing unit 300. Accordingly, by deriving the resistance Rz it is possible to determine the magnitude of applied force in the Z-direction.

FIG. 4A illustrates an example pressure sensing unit 400 included in the sensors of FIG. 2A-B. The pressure sensing unit 400 may include electrodes 402, 406, conductors 408, 412, 414 and a pressure sensitive material 401. FIGS. 4B-4D illustrate voltage divider circuit diagrams for detecting positional coordinate information (e.g., X-Z coordinate information) using three communication lines (e.g., conductors 408, 412, 414). It is also possible to detect Y-Z coordinate information using three communications line as well. As shown in FIG. 4A, electrode 402 may include conductor 408, which is arranged substantially in parallel on one side of a surface of electrode 402. In addition, electrode 406 may include conductors 412, 414, each conductor being arranged substantially in parallel on opposite sides of a surface of electrode 406. By applying a voltage across conductors 412, 414, it is possible to establish a potential between the conductors.

Referring to FIG. 4B, a voltage divider circuit diagram for detecting the position of applied force in a first direction (e.g., the X-direction) is shown. As discussed above, a voltage may be applied across conductors 412, 414 in order to establish a potential between the conductors. For example, a positive voltage may be applied to conductor 414 and conductor 412 may be grounded. The positive voltage may be 5V, for example. However, the positive voltage may be greater than or less than 5V. When a force is applied to the pressure sensing unit 400, electrodes 402, 406 may each contact the pressure sensitive material 401 at a contact point, and a voltage of electrode 406 is applied to electrode 402 via the pressure sensitive material 401 at the contact point. Then, voltage may be measured at terminal 420B (i.e., conductor 408). The voltage at terminal 420B is proportional to the distance between the contact point and conductor 408. In particular, the voltage at the terminal 420B is proportional to the sheet resistance of electrode 402 between the contact point and conductor 408. Accordingly, the position of applied force in the first direction may be derived from the voltage at terminal 420B. In addition, the conductors 412, 414 may be reversed (e.g., the positive voltage may be applied to conductor 412 and conductor 414 may be grounded).

Referring to FIGS. 4C and 4D, voltage divider circuits for detecting a magnitude of applied force in a second direction (e.g., the Z-direction) are shown. A positive voltage (e.g., 5 V) may be applied to conductor 414 of electrode 406 while conductor 412 is disconnected, as shown in FIG. 4C. In addition, conductor 408 of electrode 402 may be connected to ground through a resistor R. The resistor R may have a known value, for example 4.7 kΩ, or any other known resistance value. When a force is applied to the pressure sensing unit 400, electrodes 402, 406 may each contact the pressure sensitive material 401 at a contact point, and current may flow from conductor 414 to conductor 408 through the contact point via the pressure sensitive material 401. Then, voltage may be measured at terminal 420C (i.e., conductor 408), which represents the voltage drop across resistor R. Further, as shown in FIG. 4D, a positive voltage (e.g., 5 V) may be applied to conductor 412 of electrode 406 while conductor 414 is disconnected. In addition, conductor 408 of electrode 402 may be connected to ground through a resistor R (with a known value, for example 4.7 kΩ). When a force is applied to the pressure sensing unit 400, electrodes 402, 406 may each contact the pressure sensitive material 401 at a contact point, and current may flow from conductor 412 to conductor 408 through the contact point via the pressure sensitive material 401. Then, voltage may be measured at terminal 420D (i.e., conductor 408), which represents the voltage drop across resistor R.

By using the voltages measured at terminals 420C and 420D, it is possible to derive the value of the resistance of the conductive path (e.g., Rz shown in FIGS. 4C and 4D). For example, the resistance Rz is proportional to the sum of the inverse of the voltage measured at terminal 420C and the inverse of the voltage measured at terminal 420D. In addition, as discussed above, the resistance Rz is the resistance of the pressure sensitive material 401, which is dependent on the magnitude of the force applied to the pressure sensing unit 400. Accordingly, by deriving the resistance Rz it is possible to determine the magnitude of applied force in the Z-direction.

FIG. 5A illustrates a cross-sectional view of a pressure sensor 500 according to another implementation of the invention. The pressure sensor 500 may include a cover 520, a force concentrator 502 and a pressure sensing unit 506. The cover 520 may be a molded cover provided with in mold decoration (IMD) or in mold labeling (IML) to provide indicia and/or passive haptic features. In some implementations, the indicia may be related to the control functions. The pressure sensing unit 506 may be a pressure sensing unit configured as discussed above with regard to FIGS. 3A and 4A. The pressure sensing unit 506 may be formed inside an opening or cavity formed in a support layer 508, which is layered on top of a reaction surface 504. The physical dimensions and materials of the cover 520 may be chosen such that the cover 520 may deform under force applied by a user. For example, the cover 520 may be designed to deflect inwardly when a predetermined force is applied by the user. In addition, the physical dimensions and materials of the support layer 508 may be chosen such that a gap is defined between the cover 520 and the force concentrator 502. In this case, the cover 520 must be displaced by a predetermined distance before making contact with the force concentrator 502. The gap may also be helpful in providing design tolerances necessary to manufacture the pressure sensor 500. The physical dimensions and materials of the force concentrator 502 may also be chosen to absorb a predetermined amount of applied force. Accordingly, the design characteristics of the cover 520, force concentrator 502, support layer 508, etc. may be varied in order to configure the force response, in particular the initial force sensitivity, of the pressure sensor 500. This is discussed below with regard to FIG. 6C.

FIG. 5B illustrates various covers 520 having passive haptic features according to implementations of the invention. The covers 520 may be provided on top of a pressure-sensitive surface of the pressure sensor 500 shown in FIG. 5A, and the covers 520 may be arranged such that the passive haptic features are aligned over one or more pressure sensitive areas (e.g., pressure sensing units) of the pressure sensor 500. In addition, the passive haptic features may serve to guide a user to the pressure sensitive areas. The passive haptic features can be provided by over-molded layers 501, 503, 505, 507, for example. In particular, the over-molded layers may include combinations of embossing, debossing, protrusions, recesses, Braille, etc. as the passive haptic features. The over-molded layers 501, 503, 505, 507 may be formed separately from, or integrally with, the covers 520. In some implementations, the passive haptic features may be part of a haptic system that is in communication with the pressure sensitive system. For example, the passive haptic features may provide the user with haptic feedback based on the amount of detected force.

As shown in FIG. 5B, the passive haptic features may take many forms, including but not limited to, posts 512, ledges 514, protruding portions 516, concave portions 518 and recesses 510. For example, over-molded layer 501 includes posts 512 that flank the recess 510. The posts 512 may guide the user toward the pressure sensitive area, which may be below the recess 510. In addition, over-molded layer 503 includes ledges 514 that drop off and then taper into the recess 510, which also may guide the user to the pressure sensitive area. Further, over-molded layer 505 includes protruding portions 516 that flank the recess 510, while over-molded layer 507 includes concave portions 518 that flank the recess 510. The posts 512, ledges 514, protruding portions 516 and concave portions 518 may be any of any shape, design and/or size such that they guide the user to the pressure sensitive areas.

The pressure sensitive material may have a predictable electrical property-force response curve. Referring to FIG. 6A, an example Resistance-Force response curve of a pressure sensitive material according to an implementation of the invention is shown. As discussed above, the pressure sensitive material may be configured to change at least one electrical property (e.g., resistance) in response to force (or pressure) applied. By using such a pressure sensitive material, it may be possible to configure the sensor to detect the position of the applied force, as well as the magnitude of the applied force. One example of a pressure sensitive material is a QTC material, which is discussed above.

In FIG. 6A, the Resistance-Force response curve 600 may be divided into sections. For example, in Section A—Mechanical 610, small changes in force result in large changes in resistance. This section of the Resistance-Force response curve 600 may be useful for ON/OFF switching applications implemented with mechanical resistance due to the relatively large drop in the resistance of the pressure sensitive material based on a relatively small change in the applied force. For example, when the applied force is less than a predetermined threshold dictated wholly or partially by mechanical switching components, the pressure sensitive material may act substantially as an insulator. However, when the applied force is greater than the predetermined mechanical threshold, the pressure sensitive material may act substantially as a conductor.

In Section B—Sensor 620, the change in resistance based on a change in applied force is more linear than in Section A—Mechanical 610. In addition, the change in resistance based on a change in applied force is relatively more predictable. Thus, this section of the Resistance-Force response curve 600 may be useful for pressure sensor operations discussed below where combinations of the position and magnitude of the applied force may be correlated with a plurality of control messages. In Section C 630, large changes in force result in small changes in resistance. This section of the Resistance-Force response curve 600 may be useful for detection operations. For example, when the resistance of the pressure sensitive material falls below a predetermined value, application of a predetermined magnitude of force may be detected. As discussed below with regard to FIG. 6C, the force ranges in which Section A—Mechanical 610, Section B—Sensor 620 and Section C 630 reside may be shifted by changing the characteristics and materials of the different layers of the pressure sensor.

Referring to FIG. 6B, example Resistance-Force response curves of a pressure sensitive material according to an implementation of the invention are shown. In FIG. 6B, the Resistance-Force response curve during load removal 600A is shown. In addition, the Resistance-Force response curve during load application 600B is shown. The pressure sensitive material may act substantially as an insulator in the absence of applied force. For example, the resistance of the pressure sensitive material when no force is applied (e.g., 0 N) may exceed approximately 10¹²Ω. When substantial force is applied, the pressure sensitive material may act substantially as a conductor. For example, the resistance of the pressure sensitive material when substantial force is applied (e.g., 10 N) may be less than approximately 1Ω. The resistance of the pressure sensitive material in response to intermediate pressures of 0.5 N, 1.0 N, 2.0 N, 3.0 N and 4.0 N may be approximately less than or equal to 8 kΩ, 5 kΩ, 3 kΩ, 1.5 kΩ and 1.25 kΩ. Optionally, the resistance values discussed above may vary, for example, by 10%.

In addition, the resistance of the pressure sensitive material may continuously vary in relation to the applied force. Particularly, the pressure sensitive material may incrementally change resistance for incremental changes in applied force, however small. The variation in resistance may also be predictable over the range of applied force (e.g., between approximately 10¹² and 1Ω over an applied pressure range of 0-10 N) as shown in FIG. 6B. Moreover, the resistance of the pressure sensitive material may change substantially in real-time (i.e., instantaneously) in response to a change in the applied force. Thus, in operation, a user would not be capable of detecting any lag between the change in the resistance and the change in the applied force.

Referring to FIG. 6C, in addition to taking advantage of the pressure response provided by the pressure sensitive material, the pressure response of the sensor may be designed by changing the characteristics of other layers in the sensor, such as the cover 520, support layer 508, force concentrator 502, carrier sheets 202, 204, electrodes 203, 205, etc. discussed above with regard to FIGS. 2A-2B and 5A-5B. For example, the pressure response of the sensor may be designed by selecting the materials and physical dimensions of the other layers. By changing the materials and dimensions of the other layers, it may be possible to change how the other layers interact, for example, how much force is required to be applied to the sensor in order to apply force to the pressure sensitive material. In particular, it may be possible to offset the pressure response of the sensor either rightward (e.g., requiring more initial applied force) or leftward (e.g., requiring less initial applied force) before force is applied to the pressure sensitive material.

In some implementations, a gap (or space) may be provided to offset the pressure response of the sensor rightward by a predetermined amount of force. By providing a gap, a predetermined amount of mechanical displacement of one or more layers is required before force is applied to the pressure sensitive material. For example, a gap may be provided between the pressure sensitive material 201 and electrode 205 as shown in FIG. 2A or between the pressure sensitive material 201 and electrode 203 as shown in FIG. 2B. This gap may be provided using the adhesive bonding the carrier sheets 202, 204. Optionally, a gap may be provided between the cover 520 and the force concentrator 502 as shown in FIG. 5A. This gap may be provided using the support layer 508. The gap is not limited to the above examples, and may be provided between any two adjacent layers.

In other implementations, the sensor may be preloaded (e.g., by applying an external load to the sensor) to shift the pressure response of the sensor leftward by a predetermined amount. Preloading drops the initial resistance of the sensor by pushing the zero (external) load state rightward on the curve. For example, preloading could lower the initial resistance of the pressure sensitive material 201 before an external load is applied. Thus, at zero load, the pressure sensitive material 201 could be in the Section B 600 of the curve of FIG. 6A.

Alternatively or additionally, the materials and physical dimensions of the sensor layers may be selected to offset the pressure response of the sensor. Materials with greater thickness and lower elasticity (greater rigidity) may be used for one or more of the layers in order to offset the pressure response of the sensor rightward. By using materials with greater thickness and lower elasticity, greater force must be applied in order to displace the layers.

By utilizing the pressure sensitive material having a predictable and continuously variable electrical property-force response curve, the sensor may be easily adapted for a number of different uses. The user, for example, may take advantage of the predictable response. If a greater or lesser amount of applied force is desired before a control action is taken, the user need only look to the electrical property-force curve and select the electrical property for the desired applied force. In other words, physical redesign of the sensor is not required.

The pressure sensors 200A and 200B shown in FIGS. 2A-B may be used within the sensor of FIG. 1 to generate control messages for use in controlling various system features. For example, the sensor may be used in an automotive environment to control a variety of automotive control functions. Referring to FIG. 8, an example table of automotive functions is shown. In the automotive environment, the sensor may be used to control media systems (audio, visual, communication, etc.), driving systems (cruise control), climate control systems (heat, A/C, etc.), visibility systems (windshield wipers, lights, etc.), and other control systems (locks, windows, mirrors, etc.). In one example, the sensor may be utilized to receive a user input, such as a force applied to the sensor, and generate a control message, such as increasing or decreasing volume of a media system, based on the position and magnitude of the applied force. A table of control messages may be stored, for example, in the system memory 104 shown in FIG. 1. After storing and analyzing the user inputs, a table look-up may be performed to correlate the user inputs with particular control messages. The sensor may also be used to control many types of control system functions in many types of environments using the principles discussed herein.

As discussed above, the sensor may be configured to sense the position (e.g., one-dimensional or two-dimensional position) of the applied force, as well as a magnitude of the applied force. Combinations of the position and magnitude of the applied force may be correlated with a plurality of control messages, each control message allowing a user to control a system feature such as turning a feature ON/OFF, adjusting levels of the feature, selecting options associated with the feature, etc. For example, voltage dividers discussed above with regard to FIGS. 3B-3E and 4B-4D may be utilized to detect the position and magnitude of the applied force. In particular, when the force is applied to the sensor, electrodes may be placed into electrical communication (e.g., current flows from one electrode to the other electrode through the pressure sensitive material).

Voltages measured at the electrode(s) may then be used to calculate the position and magnitude of the applied force. Particularly, the position of the applied force in the X- and/or Y-direction may be proportional to the sheet resistance of an electrode between the contact point and the measurement terminal, and the magnitude of the applied force may be proportional to the resistance of the pressure sensitive material. In other words, electrical properties of the sensor are variable based on the position and magnitude of the applied force.

In addition, electrical properties of the sensor may be measured using the voltage dividers shown in FIGS. 3B-3E and 4B-4D, and the measured electrical properties may be associated with a time from the system clock 105 and written to the system memory 104 shown in FIG. 1. Thereafter, it may be possible to calculate the time-based change in the measured electrical properties, which may then be associated with a particular control message. For example, after calculating the time-based change in the measured electrical properties, a table look-up may be performed to correlate the time-based change to one of the control messages stored in the system memory 104 shown in FIG. 1, for example.

Referring to FIGS. 7A-7J, example gesture timing and gesture combination tables are shown. FIG. 7A is a table showing example gestures including example gesture timing and gestures per minute. Gestures can include, but are not limited to, relatively gross (or coarse) gestures made/received on the pressure sensitive input device. A gesture can optionally include a single gesture and/or a combination of gestures. The human machine interfaces provided herein facilitate an operator controlling a system in a distracted operating environment. The gestures can therefore be defined to reduce distractibility of the operator. For example, the operator might not be capable of diverting his attention from a primary task for a prolonged period of time, or much less for any period of time, to execute gestures on the pressure sensitive input device to control a secondary task without compromising the safety of the primary task. The gestures can therefore be defined as gross or coarse gestures to allow the operator to execute and the system to distinguish between different gestures. In other words, the operator might execute the gestures on the pressure sensitive input device while focusing his attention on the primary task. Example gestures include tap, hold and swipe gestures, which are discussed in detail below. It should be understood that gestures are not limited to tap, hold and swipe gestures and that other gestures can be received on the pressure sensitive input device. Gestures can optionally be characterized by a discretized time metric and/or a discretized pressure metric. For example, it is possible to distinguish between tap, hold and swipe gestures (and even between different tap gestures or hold gestures or swipe gestures) based on the discretized time and/or pressure metrics. A discretized metric can be a value range for time or pressure (e.g., tₓ<t<t_{y} or P_{X}<P<P_{y}). The size of value ranges for the discretized time and pressure metrics can be selected/tuned to reduce distractibility of the operator. For example, the operator might divert attention from the primary task (e.g., driving a vehicle) to a secondary task (e.g., looking at a user interface or controlling a system) for 3 seconds. During this 3 second period, the vehicle travels a certain distance based on the vehicle's speed. This is known as the 3 second rule. For example, a vehicle travelling 60 mph (e.g., 27 m/s) travels approximately 80 m in 3 seconds. It should be understood that this distance changes with vehicle speed. The 3 second rule can optionally be taken into account when selecting/tuning the discretized time and pressure metrics. Optionally, the size of value ranges for the discretized time and pressure metrics can be selected/tuned to facilitate the operator executing the gestures without visual feedback. For example, the size of the value ranges for the discretized time and pressure metrics can optionally be selected such that an operator can elicit a number of different system responses without diverting his attention from a primary task, for instance, driving a vehicle. By reducing distractibility of the operator, safety of the primary task is increased because the operator does not divert attention for such a prolonged, or any, period of time.

Operator distractibility may also be reduced by using active tactile feedback, which is a form of haptic feedback, and/or sound. Operators using a pressure sensitive input device may desire feedback that their inputs are being received by the system. Without some feedback, operators may look to the pressure sensitive input device, or other areas of the system such as the radio or console, in the example of a vehicle as the operating environment. This causes the operator to become distracted and lose focus from their primary task.

As described, operators of the system may use any combination of gestures, including tap, hold, and swipe gestures. Active tactile feedback, such as a vibration or depressing motion to simulate pressing a button, may be provided to an operator to indicate that the gesture was received by the system. For example, assume an operator desires to control a vehicle subsystem, such as cruise control or volume of the radio. The user may apply a force to the pressure sensitive input device, the force exceeding a first threshold, and then drag the gesture from a first position to a second position in a swipe motion. Active tactile feedback may be provided when the user first applies pressure exceeding the first threshold, during or after dragging the gesture from a first position to a second position, and/or after completing the gesture. Further, if the user applies a second amount of force while swiping, active tactile feedback may be provided to confirm receipt of the second amount of force. Further, active tactile feedback may be provided once the command has been executed.

Active tactile feedback may also be used when an operator taps or holds a pressure sensitive interface. Continuing the example above, an operator may complete the swipe to initiate or change a cruise control setting. The operator may then continue to apply force in a position to increase or decrease the speed of a vehicle, such as in one mile per hour increments, for every period of time that the operator maintains pressure in the holding position. In this example, active tactile feedback may be provided each time the vehicle increases or decreases the speed of the vehicle in each increment. In this manner, the operator receives active tactile feedback that the correct amount of pressure has been applied and the vehicle cruise-control subsystem is increasing or decreasing the speed as the operator continues to hold the pressure sensitive interface. While cruise control has been described in this example as being initiated with a swipe gesture, it may also be initiated through another gesture, such as a tap, which may also be associated with active tactile feedback for operator convenience.

Active tactile feedback may therefore be associated with the first, second, and/or third gestures, the amount of time for the gestures, and/or the amount of pressure for the gestures. Further, active tactile feedback may be provided based on the distance of a gesture. Assume volume can be increased by making a swiping gesture. In this example, active tactile feedback may be associated with swiping the correct distance to cause the volume increase command to be sent to the vehicle subsystem. The amount of active tactile feedback may also vary based on the command, so that, in this example, a large swipe indicating a large increase in volume may receive a large amount of haptic feedback. Increased or reduced active tactile feedback may be presented by varying the duration of active tactile feedback, the intensity of active tactile feedback, or any combination thereof.

The active tactile feedback device used may be located physically on or near the pressure sensitive input device, or may be separate. Active tactile feedback devices can be used to vibrate on or around pressure sensitive interfaces, such the one disclosed in U.S. application Ser. No. 13/673,463, the contents of which are expressly incorporated herein by reference in its entirety. Of course, other active tactile feedback devices may be used consistent with the disclosed system. In the example of a separate active tactile feedback device, a seat or steering wheel may vibrate to provide feedback.

In addition, sound feedback may be provided to confirm to an operator receipt of input. Sound may be provided under conditions as described above in relation to active tactile feedback. For example, sound may be provided when an operator begins a command, upon exceeding a predetermined pressure, upon exceeding a time interval, when a command has been received, during input of a command, or based on the distance of a gesture. Sound may be provided from the active tactile feedback device itself, on another dedicated speaker, or through a vehicle audio system. Sound may be used alone or in combination with other forms of haptic feedback, including active tactile feedback. Where sound is used with active tactile feedback, the sound may compliment active tactile feedback at the same time, or be provided at a separate time to supplement the active tactile feedback system.

Returning to gestures, a tap gesture can be defined as a force applied to approximately a single location of the pressure sensitive input device for less than a predetermined amount of time. Optionally, the tap gesture can be characterized by approximately continuous contact with the single location for less than the predetermined amount of time. For example, the predetermined amount of time can be less than approximately 0.5 seconds. In other words, the discretized time metric for the tap gesture can have at least one value range (e.g., between approximately 0 and 0.5 seconds). It should be understood that the predetermined amount of time can be more or less than 0.5 seconds. Optionally, the single location can be a pressure sensitive area that includes one or more pressure sensing units arranged in close proximity.

Alternatively or additionally, the tap gesture can be characterized by a discretized pressure metric. For example, the tap gesture can be characterized by the amount of force applied to the pressure sensitive input device. A tap gesture characterized by a particular amount of applied force can correspond to a particular system response. For example, a rate and/or magnitude of system response can optionally be related to the amount of applied force (e.g., the rate and/or magnitude of system response can increase/decrease based on the amount of applied force). Alternatively or additionally, the amount of applied force can have an inertial effect on the rate of system response (e.g., higher/lower rate of system response corresponds to higher/lower applied force). The discretized pressure metric can include a plurality of value ranges. For example, the plurality of value ranges for the discretized pressure metric can include a first value range defined by P₁≦P<P₂, a second value range defined by P₂≦P<P₃ and a third value range defined by P≧P₃, where P is pressure of continuous contact with the pressure sensitive input device. By providing a plurality of value ranges for the discretized pressure metric, the number of control options increases because tap gestures characterized by different pressure metrics can correspond to different responses. Optionally, the amount of force can be a peak force applied during contact. Alternatively, the amount of force can optionally be an average force applied during the contact. The discretized pressure metric can optionally include more or less than three value ranges.

A hold gesture can be defined as a force applied to approximately a single location of the pressure sensitive input device for greater than or equal to a predetermined amount of time. Optionally, the hold gesture can be characterized by approximately continuous contact with the single location for greater than or equal to the predetermined amount of time. Optionally, the single location can be a pressure sensitive area that includes one or more pressure sensing units arranged in close proximity. For example, the predetermined amount of time can be greater than or equal to approximately 1.0 second. In other words, the discretized time metric for the hold gesture can have at least one value range (e.g., greater than 1 second). Alternatively or additionally, the discretized time metric for the hold gesture can include a plurality of value ranges. For example, the plurality of value ranges for the discretized time metric can include a first value range defined by t₁≦t<t₂, a second value range defined by t₃≦t<t₄ and a third value range defined by t≧t₄, where t is time of continuous contact with the pressure sensitive input device. Optionally, t₁ can be 1 second, t₂ can be 3 seconds, t₃ can be 4 seconds and t₄ can be 6 seconds. It should be understood that that t₁, t₂, t₃ and t₄ can have other values. Similar to above, a hold gesture characterized by a particular time metric can correspond to a particular system response. For example, a rate and/or magnitude of system response can optionally be related to the time metric (e.g., the rate and/or magnitude of system response can increase/decrease based on the time metric). Alternatively or additionally, the time metric can have an inertial effect on the rate of system response (e.g., higher/lower rate of system response corresponds to higher/lower time metric). As discussed above, the number of control options increases when the discretized time metric includes a plurality of value ranges because hold gestures characterized by different time metrics can correspond to different system responses. The discretized time metric can optionally include more or less than three value ranges.

Alternatively or additionally, the hold gesture can be characterized by a discretized pressure metric. For example, the hold gesture can be characterized by the amount of force applied to the pressure sensitive input device. A hold gesture characterized by a particular amount of applied force can correspond to a particular system response. For example, a rate and/or magnitude of system response can optionally be related to the amount of applied force (e.g., the rate and/or magnitude of system response can increase/decrease based on the amount of applied force). Alternatively or additionally, the amount of applied force can have an inertial effect on the rate of system response (e.g., higher/lower rate of system response corresponds to higher/lower applied force). The discretized pressure metric can include a plurality of value ranges. For example, the plurality of value ranges for the discretized pressure metric can include a first value range defined by P₁≦P<P₂, a second value range defined by P₂≦P<P₃ and a third value range defined by P≧P₃, where P is pressure of continuous contact with the pressure sensitive input device. By providing a plurality of value ranges for the discretized pressure metric, the number of control options increases because hold gestures characterized by different pressure metrics can correspond to different responses. Optionally, the amount of force can be a peak force applied during contact. Alternatively, the amount of force can optionally be an average force applied during the contact. The discretized pressure metric can optionally include more or less than three value ranges.

A swipe gesture can be defined as a force applied between at least two points of the pressure sensitive input device. Optionally, the swipe gesture can be characterized by approximately continuous contact between at least two points of the pressure sensitive input device. For example, a swipe gesture can be force applied over a zone of the sensor. Optionally, the zone of the sensor can encompass a plurality of pressure sensitive areas that include one or more pressure sensing units. As discussed above, the position and magnitude of the applied force can be measured, and the time-based change in the position and magnitude of the applied force can be calculated. Accordingly, the path (or contour) of the applied force can be determined. An example path 900 is shown in FIG. 9. The path can be linear, curved, radial, or take any other form. The discretized time metric for the swipe gesture can include a plurality of value ranges. For example, the plurality of value ranges for the discretized time metric can include a first value range defined by t₁≦t<t₂, a second value range defined by t₂≦t<t₃ and a third value range defined by t≧t₃, where t is time of continuous contact with the pressure sensitive input device. Optionally, t₁ can be 0.4 seconds, t₂ can be 0.6 seconds and t₃ can be 1.2 seconds. This disclosure contemplates that t₁, t₂ and t₃ can have other values. Similar to above, a swipe gesture characterized by a particular time metric can correspond to a particular system response. For example, a rate and/or magnitude of system response can optionally be related to the time metric (e.g., the rate and/or magnitude of system response can increase/decrease based on the time metric). Alternatively or additionally, the time metric can have an inertial effect on the rate of system response (e.g., higher/lower rate of system response corresponds to higher/lower time metric). As discussed above, the number of control options increases when the discretized time metric includes a plurality of value ranges because swipe gestures characterized by different time metrics can correspond to different system responses. The discretized time metric can optionally include more or less than three value ranges.

Alternatively or additionally, the swipe gesture can be characterized by a discretized pressure metric. For example, the swipe gesture can be characterized by the amount of force applied to the pressure sensitive input device. A swipe gesture characterized by a particular amount of applied force can correspond to a particular system response. For example, a rate and/or magnitude of system response can optionally be related to the amount of applied force (e.g., the rate and/or magnitude of system response can increase/decrease based on the amount of applied force). Alternatively or additionally, the amount of applied force can have an inertial effect on the rate of system response (e.g., higher/lower rate of system response corresponds to higher/lower applied force). The discretized pressure metric can include a plurality of value ranges. For example, the plurality of value ranges for the discretized pressure metric can include a first value range defined by P₁≦P<P₂, a second value range defined by P₂≦P<P₃ and a third value range defined by P≧P₃, where P is pressure of continuous contact with the pressure sensitive input device. By providing a plurality of value ranges for the discretized pressure metric, the number of control options increases because hold gestures characterized by different pressure metrics can correspond to different responses. Optionally, the amount of force can be a peak force applied during contact. Alternatively, the amount of force can optionally be an average force applied during the contact. The discretized pressure metric can optionally include more or less than three value ranges.

A plurality of gestures can be characterized by different discretized time and/or pressure metrics. For example, a tap (or hold) gesture characterized by a first discretized pressure metric can be different than a tap (or hold) gesture characterized by a second discretized pressure metric. The first discretized pressure metric can be greater or less than the second discretized pressure metric. Alternatively or additionally, a tap gesture characterized by a first discretized time metric can be different than a hold gesture characterized by a second discretized time metric. The first discretized time metric can be less than the second discretized time metric. Alternatively or additionally, a swipe gesture characterized by a first discretized time metric and a first discretized pressure metric can be different than a swipe gesture characterized by a second discretized time metric or a second discretized pressure metric. The first discretized time metric and the first discretized pressure metric can be greater or less than the second discretized time metric and the second discretized pressure metric, respectively. The characteristics of example tap, hold and swipe gestures are discussed in detail below with regard to FIGS. 7B, 7C and 7F-7J. Optionally, each of the plurality of gestures can correspond to one or more control messages. By increasing the number of gestures, for example by increasing the number of discretized time and/or pressure metrics, it is possible to increase the number of control messages. Optionally, a control message can control a magnitude or rate of system response. Optionally, the magnitude of the discretized time and/or pressure metrics can have an inertial effect on the system response.

Referring now to FIG. 7B, an example tap/hold gesture response table is shown. In particular, FIG. 7B shows gesture timing and incremental responses. As discussed above, each tap or hold gesture is characterized by a discretized time metric and a discretized pressure metric. It should be understood that the discretized time and pressure metrics, as well as the corresponding responses, shown in FIG. 7B are provided only as examples and that the discretized time and pressure metrics and corresponding responses can have other values.

Tap gestures are characterized by a time metric less than 0.5 seconds and hold gestures are characterized by a time metric greater than 1.0 seconds. Additionally, tap and hold gestures are characterized by a discretized pressure metric having a plurality of value ranges (e.g., P1, P2 and P3). As discussed above, the plurality of value ranges for the discretized pressure metric can include a first value range defined by P₁≦P<P₂, a second value range defined by P₂≦P<P₃ and a third value range defined by P≧P₃, where P is pressure applied to the pressure sensitive input device. As shown in FIG. 7B, the magnitude and/or rate of incremental response increases as the magnitude of the discretized pressure metric increases from P1-P3 (e.g., P1=+1, P2=+2, P3=+3). Alternatively or additionally, the magnitude of the discretized pressure metric can have an inertial effect on the rate of system response. For example, larger discretized pressure metrics can correspond to a higher rate of system response. For example, the time to achieve a desired response (e.g., a +60 incremental response) decreases as the discretized pressure metric of the tap or hold gesture increases.

Alternatively or additionally, hold gestures are characterized by a discretized time metric having a plurality of value ranges (e.g., 1 second, 3-6 seconds and greater than 6 seconds). The plurality of value ranges for the discretized time metric can include a first value range defined by t₁≦t<t₂, a second value range defined by t₂≦t<t₃ and a third value range defined by t≧t₃, where t is time of continuous contact with the pressure sensitive input device. As shown in FIG. 7B, the magnitude and/or rate of incremental response increases as the magnitude of the discretized time metric increases from 1-6 seconds (e.g., +1 from 0-1 seconds, +2/second from 3-6 seconds and +3/second for greater than 6 seconds). Alternatively or additionally, the magnitude of the discretized time metric can have an inertial effect on the rate of system response. For example, larger discretized time metrics can correspond to a higher rate of system response. For example, the time to achieve a desired response (e.g., a +60 incremental response) decreases as the discretized time metric of the hold gesture increases.

Referring now to FIG. 7C, an example swipe gesture response table is shown. In particular, FIG. 7C shows gesture timing and incremental responses. As discussed above, each swipe gesture is characterized by a discretized time metric and a discretized pressure metric. It should be understood that the discretized time and pressure metrics, as well as the corresponding responses, shown in FIG. 7C are provided only as examples and the discretized time and pressure metrics and corresponding responses can have other values.

Swipe gestures are characterized by a discretized pressure metric having a plurality of value ranges (e.g., P1, P2 and P3). As discussed above, the plurality of value ranges for the discretized pressure metric can include a first value range defined by P₁≦P<P₂, a second value range defined by P₂≦P<P₃ and a third value range defined by P≧P₃, where P is pressure applied to the pressure sensitive input device. As shown in FIG. 7C, the magnitude and/or rate of incremental response increases as the magnitude of the discretized pressure metric increases from P1-P3 (e.g., P1=+4, P2=+8, P3=+12). Alternatively or additionally, the magnitude of the discretized pressure metric can have an inertial effect on the rate of system response. For example, larger discretized pressure metrics can correspond to a higher rate of system response. For example, the time to achieve a desired response (e.g., a +60 incremental response) decreases as the discretized pressure metric of the tap or hold gesture increases.

Alternatively or additionally, swipe gestures are characterized by a discretized time metric having a plurality of value ranges (e.g., 1.2 seconds, 0.6 seconds and 0.4 seconds). As discussed above, the plurality of value ranges for the discretized time metric can include a first value range defined by t₁≦t<t₂, a second value range defined by t₂≦t<t₃ and a third value range defined by t≧t₃, where t is time of continuous contact with the pressure sensitive input device. Alternatively or additionally, the magnitude of the discretized time metric can have an inertial effect on the rate of system response. For example, smaller discretized time metrics can correspond to a higher rate of system response. For example, the time to achieve a desired response (e.g., a +60 incremental response) decreases as the discretized time metric of the swipe gesture decreases.

Referring now to FIGS. 7D and 7E, example gesture combination response tables are shown. As discussed above, a gesture can include a combination of gestures. For example, a plurality of gestures can be combined and each combination of gestures can correspond to one or more control messages. By combining gestures, it is possible to increase the number of possible control messages. Gestures can be combined by making/receiving one gesture in temporal proximity to another gesture on the pressure sensitive input device. A time between gestures in temporal proximity can be less than or equal to a predetermined amount of time. The predetermined amount of time can be selected to differentiate between combined/related gestures and separate/unrelated gestures. For example, the predetermined amount of time can optionally be 0.5 seconds, 1 second, 1.5 seconds, etc. It should be understood that the predetermined amount of time can have other values. An increase in the total number of control messages can be proportional to the number of time and/or pressure metrics for each of the gestures.

FIG. 7D is an example tap-swipe combination gesture table. A tap-swipe combination gesture occurs when a tap gesture is executed/received in temporal proximity to a swipe gesture on the pressure sensitive input device. The number of control messages can be increased by increasing the number of discretized time and/or pressure metrics for the tap and/or swipe gestures, which increases the number of combinations. For example, if a tap gesture is characterized by a discretized time metric having one value range (e.g., less than 0.5 seconds) and a discretized pressure metric having three value ranges (e.g., P1, P2 and P3) and a swipe gesture is characterized by a discretized time metric having three value ranges (e.g., S1, S2 and S3) and a discretized pressure metric having three value ranges (e.g., P1, P2 and P3), the total number of combination (and optionally different control messages) is 27 (i.e., =3³).

FIG. 7E is an example tap-swipe-hold combination gesture table. A tap-swipe-hold combination gesture occurs when a tap gesture is executed/received in temporal proximity to a swipe gesture on the pressure sensitive input device, and the swipe gesture is executed/received in temporal proximity to a hold gesture on the pressure sensitive input device. The number of control messages can be increased by increasing the number of discretized time and/or pressure metrics for the tap, swipe and/or hold gestures, which increases the number of combinations. For example, if a tap gesture is characterized by a discretized time metric having one value range (e.g., less than 0.5 seconds) and a discretized pressure metric having three value ranges (e.g., P1, P2 and P3) and a swipe gesture is characterized by a discretized time metric having three value ranges (e.g., S1, S2 and S3) and a discretized pressure metric having three value ranges (e.g., P1, P2 and P3) and a hold gesture is characterized by a discretized time metric having one value range (e.g., greater than 1 second) and a discretized pressure metric having three value ranges (e.g., P1, P2 and P3), the total number of combination (and optionally different control messages) is 81 (i.e., =3⁴).

Referring now to FIG. 7F, an example tap-swipe combination gesture response table is shown. In particular, the tap-swipe combination gesture response table shows gesture timing and incremental responses. Optionally, the responses corresponding to different gesture combinations can be stored in a lookup table and retrieved upon receiving a gesture combination on the pressure sensitive input device. Optionally, the responses corresponding to different gesture combinations are tunable, e.g., the lookup table can be revised/updated to modify the responses. Similar to above, a tap gesture is characterized by a discretized time metric having one value range (e.g., less than 0.5 seconds) and a discretized pressure metric having three value ranges (e.g., P1, P2 and P3) and a swipe gesture is characterized by a discretized time metric having three value ranges (e.g., S1, S2 and S3) and a discretized pressure metric having three value ranges (e.g., P1, P2 and P3). Optionally, gesture combinations where swipe pressure exceeds tap pressure can be excluded from the table. For example, the table in FIG. 7F does not include a combination for “P1 Tap P3 S1 Swipe” or other combinations where swipe pressure exceeds tap pressure. As shown in FIG. 7F, a “P1 Tap P1 S1 Swipe” takes 1.7 seconds (e.g., 0.5 seconds for the tap gesture plus 1.2 seconds for the swipe gesture) and the per gesture increment is 5 (e.g., +1 for the tap gesture and +4 for the swipe gesture). The time needed to achieve +60 response is therefore 20.4 seconds (e.g., 1.7 seconds×12 gestures). Additionally, a “P3 Tap P3 S3 Swipe” takes 0.9 seconds (e.g., 0.5 seconds for the tap gesture plus 0.4 seconds for the swipe gesture) and the per gesture increment is 15 (e.g., +3 for the tap gesture and +12 for the swipe gesture). The time to +60 response is therefore 3.6 seconds (e.g., 0.9 seconds×4 gestures).

Referring now to FIGS. 7G-7I, example swipe-hold combination gesture response tables are shown. In particular, the swipe-hold combination gesture response tables show gesture timing and incremental responses. Similar to above, the responses corresponding to different gesture combinations can be stored in a lookup table and retrieved upon receiving a gesture combination on the pressure sensitive input device. Optionally, the responses corresponding to different gesture combinations are tunable, e.g., the lookup table can be revised/updated to modify the responses. Similar to above, a swipe gesture is characterized by a discretized time metric having three value ranges (e.g., S1, S2 and S3) and a discretized pressure metric having three value ranges (e.g., P1, P2 and P3). Additionally, a hold gesture is characterized by a discretized time metric having a plurality of value ranges (e.g., 1-3 seconds, 4-6 seconds and greater than 6 seconds) and a pressure metric having three value ranges (e.g., P1, P2 and P3). As shown in FIG. 7G, a “P1 S1 Swipe P1 Hold” takes 2.2 seconds (e.g., 1.2 seconds for the swipe gesture plus 1 second for the hold gesture) and the per gesture increment is 5 (e.g., +4 for the swipe gesture and +1 for the hold gesture). Additionally, by maintaining the hold gesture for greater than 1 second, the incremental response increases (e.g., +1/second from 1-3 seconds, +2/second from 4-6 seconds and +3/second after 6 seconds). The time needed to achieve +60 response is therefore 22.8 seconds (e.g., +5 for the initial gesture (2.2 seconds), +8 for the hold between 1 second and 6 seconds (5 seconds) and +47 after 6 seconds (47/3=15.6 seconds). FIG. 7H is similar to FIG. 7G but with a 1.6 second gesture timing for “P1 S2 Swipe P1 hold.” Additionally, as shown in FIG. 7I, a “P3 S3 Swipe P3 Hold” takes 1.4 seconds (e.g., 0.4 seconds for the swipe gesture plus 1 second for the hold gesture) and the per gesture increment is 15 (e.g., +12 for the swipe gesture and +3 for the hold gesture). Additionally, by maintaining the hold gesture for greater than 1 second, the incremental response increases (e.g., +3/second from 1-3 seconds, +4/second from 4-6 seconds and +5/second after 6 seconds). The time needed to achieve +60 response is therefore 11.8 seconds (e.g., +15 for the initial gesture (1.4 seconds), +18 for the hold between 1 second and 6 seconds (5 seconds) and +27 after 6 seconds (27/5=5.4 seconds).

Referring now to FIG. 7J, an example tap-swipe-hold combination gesture response table is shown. In particular, the tap-swipe-hold combination gesture response table shows gesture timing and incremental responses. Similar to above, the responses corresponding to different gesture combinations can be stored in a lookup table and retrieved upon receiving a gesture combination on the pressure sensitive input device. Optionally, the responses corresponding to different gesture combinations are tunable, e.g., the lookup table can be revised/updated to modify the responses. Similar to above, a tap gesture is characterized by a discretized time metric having one value range (e.g., less than 0.5 seconds) and a swipe gesture is characterized by a discretized time metric having three value ranges (e.g., S1, S2 and S3) and a discretized pressure metric having three value ranges (e.g., P1, P2 and P3). Additionally, a hold gesture is characterized by a discretized time metric having a plurality of value ranges (e.g., 3-6 seconds and greater than 6 seconds) and a discretized pressure metric having three value ranges (e.g., P1, P2 and P3). Optionally, combinations where swipe pressure exceeds tap pressure can be excluded from the table. For example, the table in FIG. 7J does not include a combination for “P1 Tap P3 S1 Swipe P1 Hold” or other combinations where swipe pressure exceeds tap pressure. Optionally, a tap gesture can activate the gesture combination, the gesture combination can be executed/received and the hold gesture can set the incremental response. For example, as shown in FIG. 7J, the tap-swipe portion of a “P1 Tap P1 S1 Swipe P1 Hold” takes 1.7 seconds (e.g., 0.5 seconds for the tap gesture plus 1.2 seconds for the swipe gesture) and the initial gesture increment is 5 (e.g., +1 for the tap gesture and +4 for the swipe gesture). Additionally, by maintaining the hold gesture, the incremental response increases (e.g., +1/second from 1-3 seconds, +2/second from 3-6 seconds and +3/second 6 seconds). The time needed to achieve +60 response is therefore 23.0 seconds (e.g., +5 for the initial gesture (1.7 seconds), +9 for the hold between 0 seconds and 6 seconds (6 seconds) and +46 after 6 seconds (46/3=15.3 seconds).

Referring now to FIG. 7K, a chart showing the fastest and slowest responses for the gestures and gesture combinations in the examples of FIGS. 7B, 7C and 7F-7J is shown. The chart illustrates the fastest and slowest times needed to achieve +60 response from FIGS. 7B, 7C and 7F-7J. In particular, the chart illustrates that a plurality of swipe gestures characterized by discretized time and pressure metrics yield the fastest response. Additionally, a plurality of tap gestures characterized by discretized pressure metrics yield the slowest response.

Referring now to FIG. 10A, an average Resistance-Force response curve 1301 according to an implementation of the invention is shown. The average Resistance-Force response curve 1301 illustrates the average response obtained during testing of a sensor according to implementations discussed herein. In FIG. 10A, lines 1303A, 1303B and 1303C estimate the sensitivity of the Resistance-Force response curve 1301 in first, second and third regions, respectively. For example, line 1303A estimates the sensitivity of the sensor in response to applied forces between 0 and 0.6N. Line 1303B estimates the sensitivity of the sensor in response to applied forces between 0.7 and 1.8N. Line 1303C estimates the sensitivity of the sensor in response to applied forces between 1.9 and 6N. In particular, the sensitivity of the sensor can be defined by Eqn. (1), below.

Sensitivity=Sensor Value−Sensor Origin/Force Value (1)

In the first, second and third regions, the sensor origins are approximately 10.00 kΩ, 2.43 kΩ and 1.02 kΩ, respectively. Accordingly, the sensitivities of the sensor in the first, second and third regions are approximately −13,360 Ω/N, −799 Ω/N and −80 Ω/N, respectively.

Referring now to FIGS. 10B and 10C, example power log function curves fitting the three-sigma Resistance-Force response curves of FIG. 10A are shown. For example, a power log function curve can be determined that fits the average response data obtained during testing of the sensor. The power log function curve can then be utilized to model or predict applied force values based on measured resistance values. FIGS. 10B and 10C show the power log function curve 1305 that fits the example average Resistance-Force response curve 1301. The power log function curve 1305 can be defined by Eqn. (2) below.

Resistance=1732.8*Applied Forcê−0.739 (2)

The coefficient of determination (R²) for the power log function curve 1305 is 0.9782. In addition, FIG. 10C shows example power log function curves fitting the three-sigma Resistance-Force response curve of FIG. 10A. Power log function curve 1305A fits the −3-sigma Resistance-Force response curve, and power log function curve 1305B fits the +3-sigma Resistance-Force response curve. Power log function curves 1305A and 1305B can be defined by Eqns. (3) and (4) below, respectively.

Resistance=2316.1*Applied Forcê−0.818 (3)

Resistance=1097.5*Applied Forcê−0.561 (4)

In addition, the coefficients of determination (R²) for the power log function curves 1305A and 1305B are 0.9793 and 0.888, respectively.

Different operators (and even the same operator at different times) can interact with a pressure sensitive input device in different manners. For example, one operator might have large hands and/or execute gestures in a more aggressive manner. In contrast, a different operator might have small hands and/or execute gestures in a gentler manner. It should be understood that these two operators might execute the same gesture (e.g., a tap, hold or swipe gesture) while applying different amounts of force to the pressure sensitive input device. For example, when executing a swipe gesture, the “aggressive” operator applies a larger force to the pressure sensitive input device than the “gentler” operator. Both operators, however, might desire to elicit the same or similar system response. Accordingly, pressure metrics of gestures can be adjustable according to one or more characteristics of the operator.

As discussed above, a gesture can be characterized by a discretized pressure metric. Optionally, the pressure metric has a plurality of value ranges. Additionally, the gesture can optionally be characterized by a discretized time metric. Optionally, a gesture can include a combination of gestures (e.g., at least two gestures received in temporal proximity). Each of the value ranges for the discretized pressure metric can optionally be selected/defined using a predictable electrical property-force response curve such as the Resistance-Force response curve 600 shown in FIG. 6A, for example. The value ranges for the discretized pressure metric can optionally be located in Section B—Sensor 620 of the Resistance-Force response curve 600. As discussed above, the change in resistance corresponding to a change in applied force is relatively more predictable in Section B—Sensor 620 as compared to other sections of the response curve.

The value ranges for the discretized pressure metric can be adjusted according to one or more characteristics of a particular operator. The characteristics of the operator can be stored in the memory, for example. The characteristics of the operator can optionally be associated with an identifier for the operator. Thus, characteristics for a plurality of different operators can be stored in the memory. Each operator can therefore provide (e.g., command, enter, select, etc.) an identifier to a controller for the pressure sensitive input device, and the value ranges for the discretized pressure metric can be adjusted according to the particular operator's characteristics. Optionally, characteristics of the particular operator can include a typical force applied to the pressure sensitive input device. The typical applied force can optionally be a peak or average applied force during operations by the particular operator. For example, the typical applied force can optionally be the peak or average force applied to the pressure sensitive input device during a period of time. The period of time can be any period of time and can include, but is not limited to, historical data. Optionally, a controller for the pressure sensitive input device can record (e.g., store in memory) pressure applied to the pressure sensitive input device by the particular operator over time. The controller can periodically or continuously update the typical applied force. The controller therefore can learn the characteristics of the particular operator and adjust the value ranges for the discretized pressure metric according to the characteristics of the operator.

Referring now to FIG. 11, example value ranges for a discretized pressure metric for two different operators (or the same operator at different times) relative to an electrical property-force response curve are shown. Although two value ranges for the discretized pressure metric are shown in FIG. 11, it should be understood that more or less than two value ranges for the discretized pressure metric can be used. As discussed above, the electrical property-response curve can have a predictable response. Optionally, the electrical property-force response curve can be defined by a power log curve. Alternatively or additionally, the electrical property-force response curve can optionally be a resistance-force response curve. The value ranges P1x and P2x for the discretized pressure metric for a first operator 1102 and the value ranges P1y and P2y for the discretized pressure metric for a second operator 1104 are shown in FIG. 11. The value ranges P1y and P2y for the discretized pressure metric for the second operator 1104 are shifted (e.g., to the right) along the electrical property-response curve relative to the value ranges P1x and P2x for the discretized pressure metric for the first operator 1102. The second operator 1104 therefore applies a greater amount of force to the pressure sensitive input device to execute a gesture characterized by the pressure metric shown in FIG. 11.

It should be understood that the various techniques described herein may be implemented in connection with hardware, firmware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Referring now to FIG. 12A, a flow chart illustrating example operations 1200 for providing an adaptive human machine interface for decreasing distractibility of an operator controlling a system in a distracted environment is shown. At 1202, a gesture can be received on a pressure sensitive input device. The gesture can include a single gesture or a combination of gestures. The gesture can also be characterized by a discretized pressure metric having a plurality of value ranges. Optionally, the gesture can also be characterized by a discretized time metric. At 1204, a control message can be selected from a plurality of control messages based on the gesture. At 1206, the selected control message can be sent to the system. As discussed above, the size of each of the value ranges for the discretized pressure metric can be tuned to reduce distraction of the operator. Additionally, each of the value ranges for the discretized pressure metric can be defined based on a predictable electrical property-force response curve for the pressure sensitive input device. Further, the value ranges can be adjustable according to at least one characteristic of the operator. Optionally, at 1208, at least one of the value ranges for the pressure metric can be adjusted according to a characteristic of the operator.

Referring now to FIG. 12B, a flow diagram illustrating example operations 1220 for providing an adaptive human machine interface that increases selectability and reduces distractibility of an operator controlling a system in a distracted environment is shown. At 1222, a combination of gestures can be received on a pressure sensitive input device. The combination of gestures can include at least two gestures received in temporal proximity, and each of the at least two gestures can be characterized by a discretized pressure metric having a plurality of value ranges and a discretized time metric. At 1224, a control message can be selected from a plurality of control messages based on the combination of gestures. At 1226, the selected control message can be sent to the system. As discussed above, the sizes of each of the value ranges for the discretized pressure metric and the discretized time metric can be tuned to reduce distraction of the operator. Additionally, the value ranges can be adjustable according to at least one characteristic of the operator. Optionally, at 1228, at least one of the value ranges for the pressure metric at least one of the gestures can be adjusted according to a characteristic of the operator.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for providing an adaptive human machine interface that decreases distractibility of an operator controlling a system in a distracted operating environment, comprising:
receiving a gesture on a pressure sensitive input device, the gesture being characterized by a discretized pressure metric having a plurality of value ranges;
selecting a control message from a plurality of control messages based on the gesture; and
sending the selected control message to the system,
wherein each of the value ranges for the discretized pressure metric is defined based on a predictable electrical property-force response curve for the pressure sensitive input device, and
wherein the value ranges are adjustable according to at least one characteristic of the operator.

2. The method of claim 1, further including providing at least one of active tactile feedback or a sound in response to at least one of receiving the gesture or selecting the control message.

3. The method of claim 1, further comprising:
learning the at least one characteristic of the operator; and
adjusting the value ranges of the discretized pressure metric based on the at least one characteristic of the operator, wherein at least one of the value ranges of the discretized pressure metric is shifted along the predictable electrical property-force response curve.

4. The method of claim 1, wherein the at least one characteristic of the operator is at least one of a peak or average force applied to the pressure sensitive input device.

5. The method of claim 1, wherein the predictable electrical property-force response curve is at least one of a power log curve or a resistance-force response curve.

6. The method of claim 1, wherein the gesture is further characterized by a time metric.

7. The method of claim 1, wherein the gesture comprises at least two gestures received in temporal proximity on the pressure sensitive input device, each of the gestures being characterized by a discretized pressure metric having a plurality of value ranges and a time metric, and wherein the control message is selected based on a combination of the at least two gestures.

8. The method of claim 1, wherein the gesture comprises one or more of a tap gesture, a hold gesture, and a swipe gesture.

9. A system, comprising:
a pressure sensitive input device;
a memory; and
a processor in communication with the memory, the processor configured to:
receive a signal corresponding to a gesture received on the pressure sensitive input device, the signal being characterized by a discretized pressure metric having a plurality of value ranges;
select a control message from a plurality of control messages based on the gesture; and
send the selected control message to a sub-system being controlled,
wherein each of the value ranges for the discretized pressure metric is defined based on a predictable electrical property-force response curve for the pressure sensitive input device, and
wherein the value ranges are adjustable.

10. The system of claim 9, further including at least one of:
an active tactile feedback device that provides haptic feedback in response to at least one of receiving the gesture or selecting the control message; or
a speaker that provides a sound in response to at least one of receiving the gesture or selecting the control message.

11. The system of claim 9, wherein the processor is further configured to:
learn at least one characteristic of an operator; and
adjust the value ranges of the discretized pressure metric based on the at least one characteristic of the operator, wherein at least one of the value ranges of the discretized pressure metric is shifted along the predictable electrical property-force response curve.

12. The system of claim 11, wherein the at least one characteristic of the operator is at least one of a peak or average force applied to the pressure sensitive input device.

13. The adaptive human machine interface of claim 9, wherein the predictable electrical property-force response curve is at least one of a power log curve or a resistance-force response curve.

14. The system of claim 9, wherein the gesture is further characterized by a time metric.

15. The system of claim 9, wherein the gesture comprises at least two gestures received in temporal proximity on the pressure sensitive input device, each of the gestures being characterized by a discretized pressure metric having a plurality of value ranges and a time metric, and wherein the control message is selected based on a combination of the at least two gestures.

16. The system of claim 9, wherein the gesture comprises one or more of a tap gesture, a hold gesture, and a swipe gesture.

17. A computer readable medium comprising instructions which, when executed by a processor, perform a method comprising:
receiving a gesture on a pressure sensitive input device, the gesture being characterized by a discretized pressure metric having a plurality of value ranges;
selecting a control message from a plurality of control messages based on the gesture; and
sending the selected control message to a sub-system being controlled,
wherein each of the value ranges for the discretized pressure metric is defined based on a predictable electrical property-force response curve for the pressure sensitive input device, and
wherein the value ranges are adjustable.

18. The computer-readable medium of claim 17, wherein the method further includes providing at least one of active tactile feedback or a sound in response to at least one of receiving the gesture or selecting the control message.

19. The computer-readable medium of claim 17, wherein the method further includes:
learning at least one characteristic of an operator; and
adjusting the value ranges of the discretized pressure metric based on the at least one characteristic of the operator, wherein at least one of the value ranges of the discretized pressure metric is shifted along the predictable electrical property-force response curve.

20. The computer-readable medium of claim 17, wherein the method further including:
receiving a plurality of gestures; and
selecting the control message based on the plurality of gestures.
